(19) United States
(12) Patent Application Publication
(10) Pub. No.: US 2002/0030339 A1
(43) Pub. Date: Mar. 14, 2002

(54) Scooter

(76) Inventor: Ronald H. Powers, Newport Beach, CA (US)

Correspondence Address: John H. Lynn, Suite F 200, 2915 Redhill Avenue, Costa Mesa, CA, 92626, US

(21) Appl. No.: 09/948,367

(22) Filed: Sep. 6, 2001

Related U.S. Application Data
(60) Provisional application No. 60/230,349, filed on Sep. 6, 2000.

(51) Int. Cl. B62M 1/00; B62B 5/04

(52) U.S. Cl. 280/87.041; 188/19

(57) ABSTRACT

A wheeled vehicle includes a platform mounted between a front wheel assembly and a rear wheel assembly. The rear wheel assembly includes a speed control assembly that comprises a pedal, a shoe mounted to the pedal and a spring arranged to bias the shoe away from a rear wheel. The pedal is arranged so that a person standing on the platform may press on the pedal with one foot to move the shoe into contact with the real wheel to produce friction for controlling the speed of the wheeled vehicle.

CROSS REFERENCE TO RELATED APPLICATION

Applicant claims the benefit of US Provisional Application Ser. No. 60/230,349, filed Sep. 6, 2000 for Scooter.

### BACKGROUND OF THE INVENTION

This invention relates to a vehicle commonly known as a scooter.

SUMMARY OF THE INVENTION

A wheeled vehicle according to the invention includes a platform mounted between a front wheel assembly and a rear wheel assembly. The rear wheel assembly includes a speed control assembly that comprises a pedal, a shoe mounted to the pedal and a spring arranged to bias the shoe away from a rear wheel. The pedal is arranged so that a person standing on the platform may press on the pedal with one foot to move the shoe into contact with the real wheel to produce friction for controlling the speed of the wheeled vehicle.

The rear wheel assembly preferably includes a rear fender with the pedal being arranged to extend through a hole in the rear fender and the spring having an end mounted to the rear fender.

The wheeled vehicle preferably further includes a brake light assembly mounted in the rear fender with the brake light assembly including a light source arranged to turn on when pressure is applied to the pedal. The brake light assembly preferably includes a push button on-off switch arranged to be actuated by the pedal.

### BRIEF DESCRIPTION OF THE DRAWINGS

FIG. 1 is a rear perspective view of a scooter according to the present invention;

FIG. 2 is a rear perspective view of a scooter according to the present invention;

FIG. 3 is a right side elevation view of a scooter according to the present invention;

FIG. 4 is a rear elevation view of a scooter according to the present invention;

FIG. 5 is a front elevation view of a scooter according to the present invention;

FIG. 6 is a top plan view of a scooter according to the present invention;

FIGS. 7 and 8 are perspective views of a rear fender that may be included in a scooter according to the present invention;

FIG. 9 is a side elevation view of the rear fender of FIGS. 7 and 8 with part of the rear fender being cut away to show a brake assembly and a brake light assembly mounted in the rear fender;

FIGS. 10 and 11 are perspective views of a brake assembly that may be included in the rear fender shown in FIGS. 7-9;

FIG. 12 is a perspective view of a front portion of a scooter according to the present invention;

FIG. 13 is a side elevation view of the front portion shown in FIG. 12;

FIG. 14 is a top plan view of the front portion shown in FIGS. 12 and 13;

FIG. 15 is a top plan view of a platform that may be included in a scooter according to the present invention;

FIG. 16 is a side elevation view of the platform of FIG. 15;

FIG. 17 is a perspective view of the platform of FIGS. 15 and 16; and

FIG. 18 is a perspective view of a portion of a handlebar assembly that may be included in a scooter according to the present invention.

### DETAILED DESCRIPTION OF THE INVENTION

The prior art is replete with descriptions of scooters and other two wheeled vehicles. However, the present invention is directed to features that the prior art fails to disclose or suggest and that make the scooter according to the present invention more enjoyable to use.

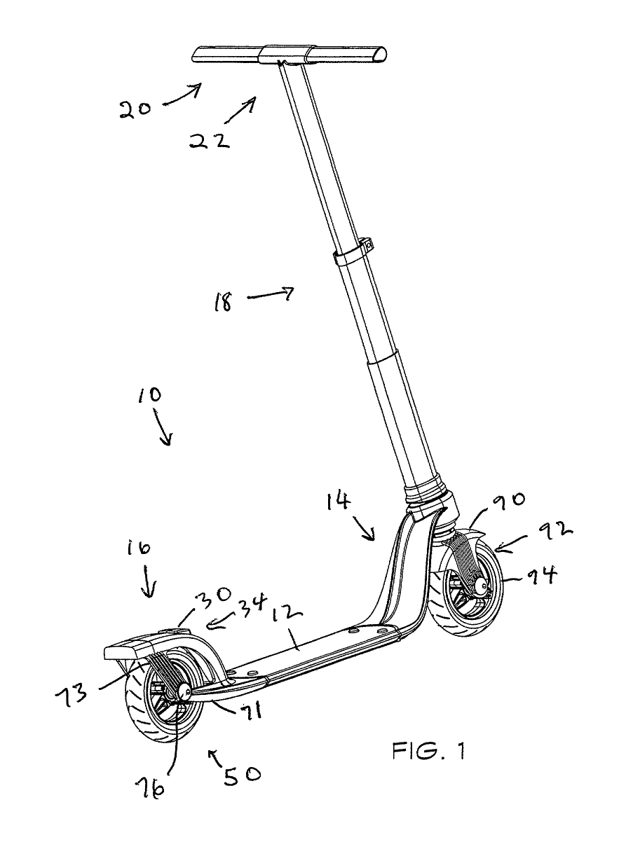

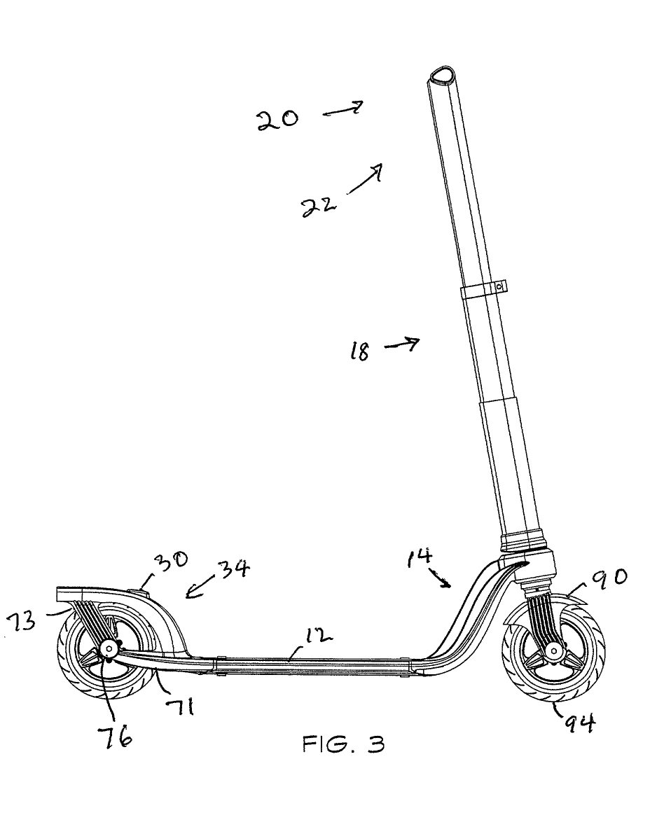

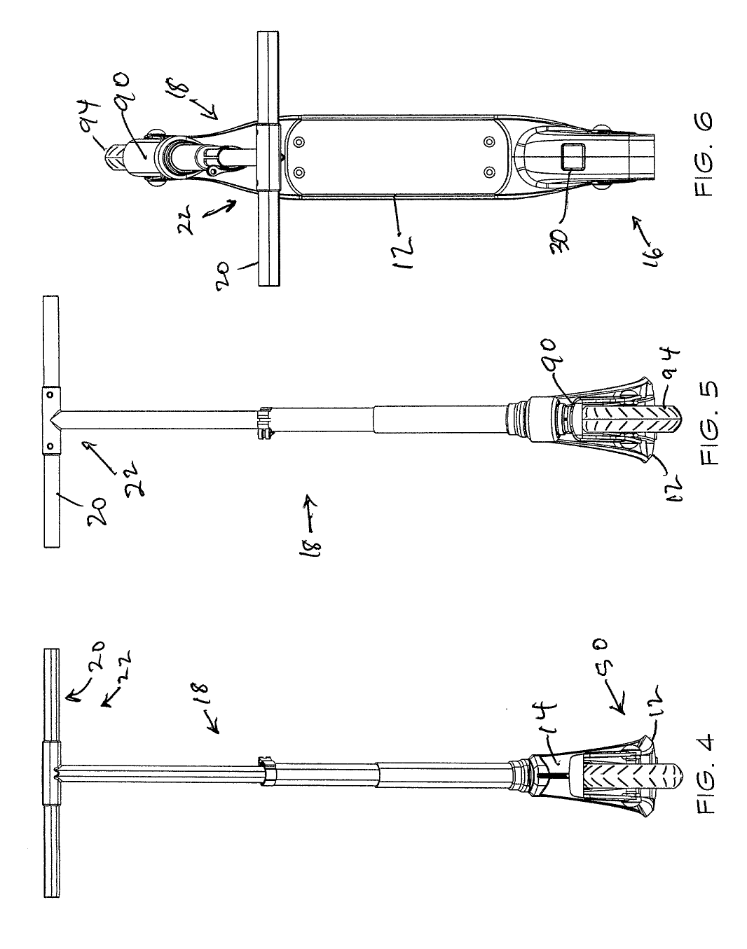

Referring to FIGS. 1-6, a scooter 10 according to the present invention includes a platform 12 mounted between a front wheel assembly 14 and a rear fender 16. A steering column 18 extends upward away from the front wheel assembly 14. A handlebar 20 is mounted to the upper end 22 of the steering column 18.

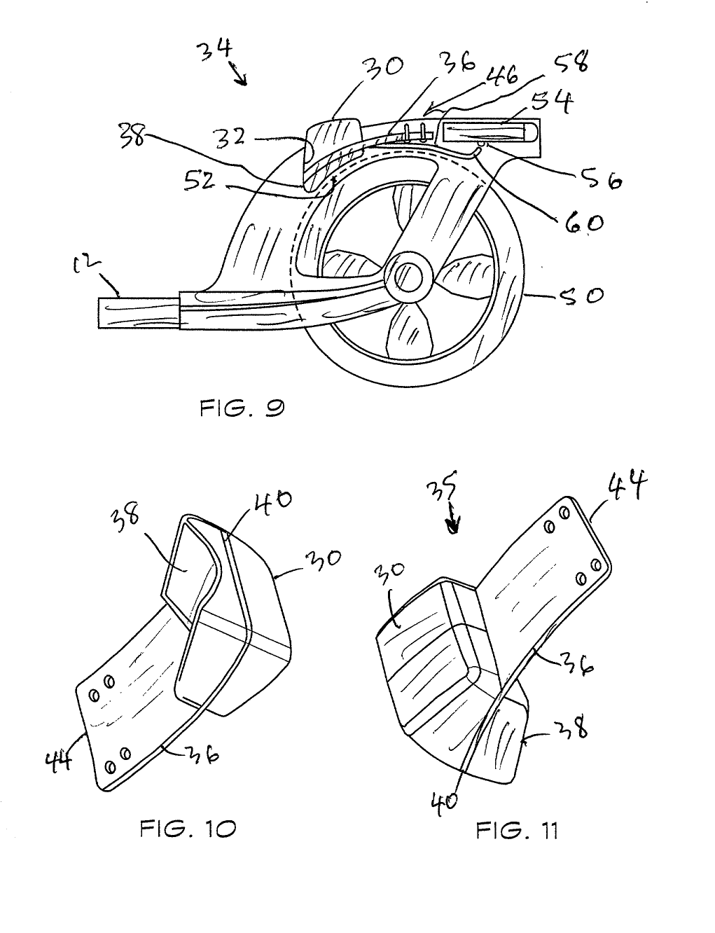

Referring to FIGS. 1-3, and 6-11, a pedal 30 extends through an opening 32 in a front portion 34 of the rear fender 16. The pedal 30 is a part of a speed control assembly 35 that also includes a spring 36 and a shoe 38. The pedal 30 and the shoe 38 are mounted on opposite sides of the spring 36 near a first end 40. A plurality of holes 42 is formed in the spring 36 near the opposite end 44. Fasteners 46 are inserted in the holes 42 and used to secure the speed control assembly 35 to the rear fender 16 with the spring 36 extending rearward.

A rear wheel 50 is mounted in the rear fender so that an upper portion of the rear wheel 50 is near the lower surface of the shoe 38. A person riding the scooter 10 presses on the pedal 30 with one foot to actuate the speed control assembly 35. Downward pressure on the pedal 30 engages the lower surface of the shoe 38 with the adjacent surface 52 of the rear wheel 50 to produce friction for controlling the speed of the scooter 10.

The location of the pedal 30 allows a person riding the scooter 10 to put most of his weight on one foot placed behind the pedal 30, which allows the rider to lift the front wheel and ride only on the rear wheel (“wheelie”). A fender extension may be added to facilitate this maneuver.

Referring now to FIG. 9, the scooter 10 may also include a light that turns on and off depending on the pressure applied to the pedal 30. A battery powered light source 54 such a light emitting diode (LED) or a laser is mounted in the rear fender 16. The light source 54 includes a push-button on-off switch 56. A light switch actuator spring 58 is connected to the brake spring 36 and arranged so that downward rotation of the brake spring 36 causes an end 60 of the light switch actuator spring 58 to move upward and actuate the switch 56. Removal of pressure from the brake pedal 30 disengages the end 60 of the spring 58 from the light switch, which turns off the light. The light source 54 may provide either a continuously on light or a flashing light as long as it is turned on.

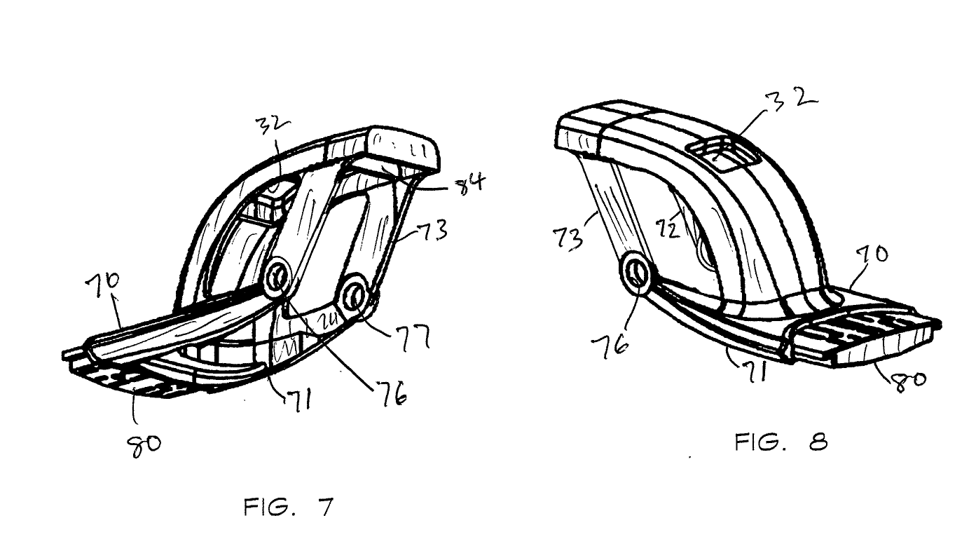

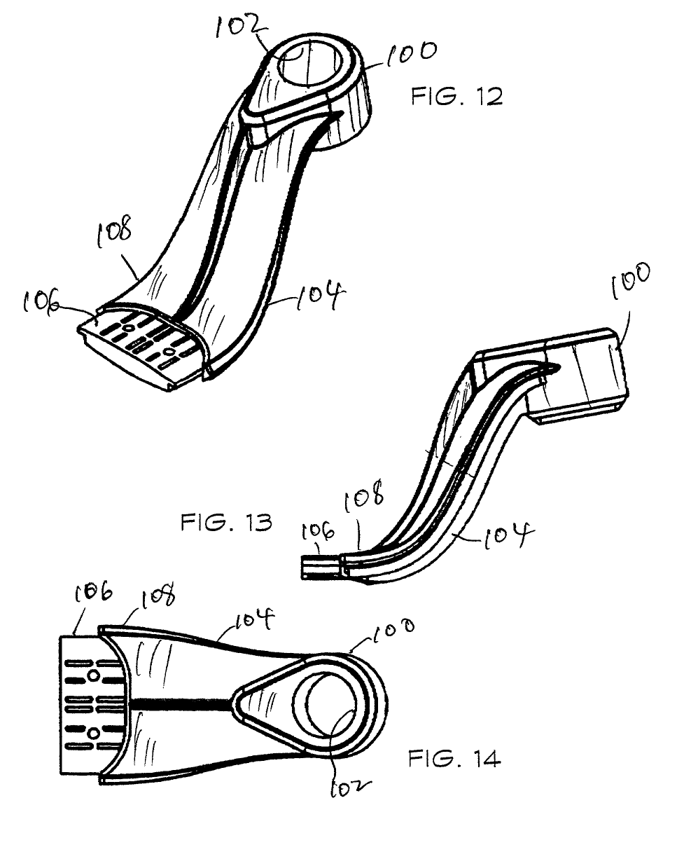

Referring now to FIGS. 7, 8, and 12-17, the platform 12, the front wheel 14 and the rear fender 16 may be formed as separate modules that are then assembled together. As shown in FIGS. 7 and 8, the rear fender includes horizontal support members 70 and 71 and vertical support members 72 and 73. An axle hole 76 is formed in the rear fender assembly at the junction of the horizontal support member 70 and the vertical support member 72. In like manner, an axle hole 77 is formed in the rear fender assembly at the junction of the horizontal support member 71 and the vertical support member 73.

A projection 80 extends from the front portion of the rear fender assembly 16. The projection 80 is formed to fit inside a recess 82 in the rear end of the platform 12. Fasteners such as bolts or screws (not shown) are used to secure the rear fender assembly 16 and the platform 12 together.

A flexible rear bumper may be added to the rear fender. As shown in FIG. 7, the rear fender may include a recess 84 into which a battery powered tail light may be mounted.

Referring to FIGS. 1-6, the front assembly 14 includes a front fender 90, a fork 92 and a front wheel 94 mounted to the fork 92.

Referring to FIGS. 12-14, the front assembly 14 includes a steering column support ring 100 that has a hole 102 therein for receiving the steering column 18. The lower end of the steering column 18 extends through the hole 102 to be secured to the top of the front fender 90 so that turning movements of the steering column are transferred to the front wheel.

A yoke 104 extends from the column support ring 100. A projection 106 extends from an end 108 of the yoke 104. The projection 106 is formed to fit inside a recess 110 in the rear end of the platform 12. Fasteners such as bolts or screws (not shown) are used to secure the front assembly 14 and the platform 12 together.

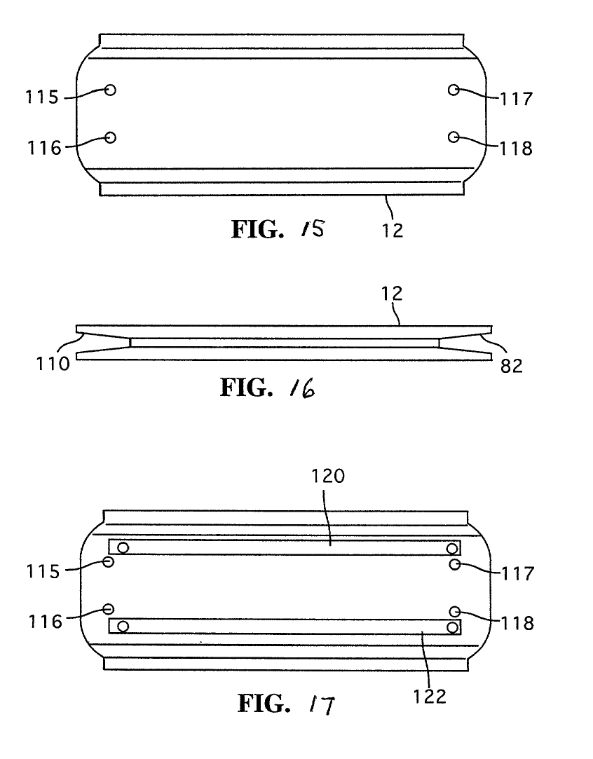

The platform 12 is formed generally as an elongate rectangle when viewed seen in the top plan view of FIG. 15. As shown in FIGS. 16 and 17, the platform is relatively thin in relation to its length. For example, the platform could have a length of about 24″ and a thickness of about 0.5 to 1″. The platform 12 includes a holes 115-118 that are used to mount the platform 12 to the front and rear assemblies 12 and 16, respectively.

FIG. 17 shows the bottom side of the platform 12. A pair of grind plates 120 and 122 is mounted to the bottom of the platform 12 via suitable fasteners such as screws or bolts. It is anticipated that users of the scooter 10 will cause the grind plates 120 and 122 to rub (grind) against curbs, steps, stair rails and the like. The grind plates 120 and 122 are replaceable and are preferably formed of a substance such a polyolefin etc. that facilitates sliding.

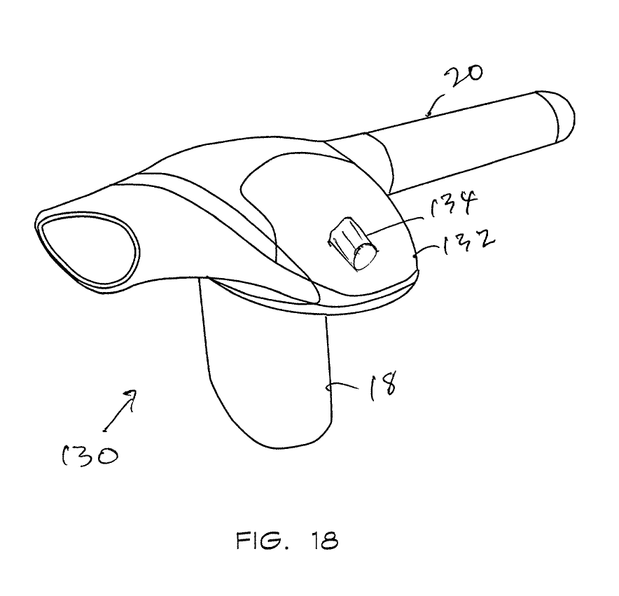

The handle bar 20 is mounted to the top of the steering column 18. Referring to FIG. 18, a handlebar assembly 130 includes a lens 132 that covers a cavity 134 in which a battery powered headlight is mounted. Lights used in the scooter 10 are commercially available.

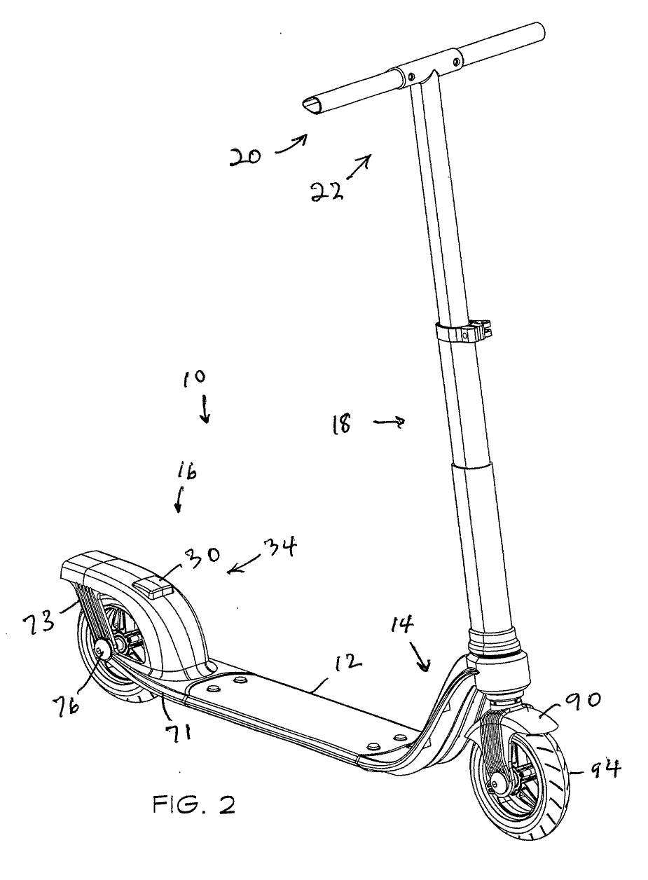

The steering column 18 may be hinged mounted so that it can be folded to be generally parallel to the platform 12 as shown in FIG. 2. The hinged connection may also include a commercially available lock.

The scooter 10 may include a front suspension that includes a coil spring to reduce bouncing and to reduce forces transmitted to the rider from the steering column 18.

What is claimed is:

1. A wheeled vehicle that includes a platform mounted between a front wheel assembly and a rear wheel assembly, the rear wheel assembly including a speed control assembly that comprises a pedal, a shoe mounted to the pedal and a spring arranged to bias the shoe away from a rear wheel, the pedal being arranged so that a person standing on the platform may press on the pedal with one foot to move the shoe into contact with the real wheel to produce friction for controlling the speed of the wheeled vehicle.

2. The wheeled vehicle of claim 1 wherein the rear wheel assembly includes a rear fender, the pedal extending through a hole in the rear fender and the spring having an end mounted to the rear fender.

3. The wheeled vehicle of claim 2, further including a brake light assembly mounted in the rear fender, the brake light assembly including a light source arranged to turn on when pressure is applied to the pedal.

4. The wheeled vehicle of claim 3 wherein the brake light assembly includes a push button on-off switch arranged to be actuated by the pedal.

5. The wheeled vehicle of claim 2 wherein the rear fender includes a recess in which a tail light may be mounted.
